(19) United States
(12) Patent Application Publication
(10) Pub. No.: US 2005/0026644 A1
(43) Pub. Date: Feb. 3, 2005

(54) Cellular phone for specific person

(75) Inventor: Shun-Yi Lien, Taipei Hsien (TW)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei Hsien (TW)

(21) Appl. No.: 10/627,808

(22) Filed: Jul. 28, 2003

(51) Int. Cl. H04Q 7/20

(52) U.S. Cl. 455/550.1

(57) ABSTRACT

The present invention is to provide a cellular phone for a specific person who is not skilled in operating a typical cellular phone, which comprises a plurality of shortcut keys and a plurality of software packages installed in a control circuit, the software packages being linked to the shortcut keys so that a pressing of one of the shortcut keys causes a corresponding software package to run for commanding the cellular phone to make a call by dialing a selected one of a plurality of predetermined phone numbers. Thus, the manufacturing cost of the cellular phone will be significantly reduced due to without having complicated function keys or complicated software packages, and a user can easily use the cellular phone without worrying about how to operate it.

### FIELD OF THE INVENTION

The present invention relates to cellular phones and more particularly to a cellular phone for a specific person (e.g., old person or child) with improved characteristics.

### BACKGROUND OF THE INVENTION

The world we are living in has entered into a new era with information technology and electronics industry prosperously being developed. All kinds of high technology and mobile communication products are invented due to the fast progress in computer and network technologies. Also, more and more people like to use high technology and mobile communication products due to advantages of compactness, powerfulness, and inexpensiveness. Particularly, cellular phones are the most widely used mobile communication products among people. Cellular phones are thus closely related to our daily life and work. The widely used mobile communication products shorten time required for communication between people in different geographical areas. In response to all kinds of new information products being developed, most users become more critical with respect to the convenience in using them. Thus, whether a mobile communication product produced in the future can provide a more convenient and effective characteristic will be an indicator to decide whether the manufacturing technology of the mobile communication product owned by one company is more advanced than that owned by other companies.

Nowadays, more advanced features (e.g., short messages sending or receiving, Internet access, phone number memory, call mode setting, ring editing, standby screen setting, calculator, etc.) are provided by cellular phones. Hence, a user can select one of the features depending on his/her need. However, more features of a cellular phone may cause confusion for some specific persons (e.g., children, old persons, or the like) while using it. This is because for most children or old persons they cannot easily or even are unable to operate powerful, complicated cellular phones. Further, they usually do not need such cellular phones either.

Thus, it is desirable among mobile communication product manufactures to provide a cost effective, simple cellular phone specifically designed for an old person or child in order to overcome the above drawback of the prior art.

### SUMMARY OF THE INVENTION

A primary object of the present invention is to provide a cellular phone for a specific person who is not skilled in operating a typical cellular phone. For being adapted to different modes of use, in one case that the cellular phone comprises a plurality of shortcut keys and a plurality of software packages installed in a control circuit, the software packages being linked to the shortcut keys so that a pressing of one of the shortcut keys causes a corresponding software package to run for commanding the cellular phone to make a call by dialing a selected one of a plurality of predetermined phone numbers. Hence, a user can easily use the cellular phone without worrying about how to operate it. Further, neither complicated function keys nor complicated software packages are provided on the cellular phone, resulting in a significant reduction of the manufacturing cost of the cellular phone. By utilizing the present invention, the above drawbacks of the prior art can be overcome. These drawbacks are that many old persons or children are not skilled in using powerful, complicated cellular phones. Further, they usually do not need such cellular phones either.

One object of the present invention is to provide a cellular phone designed specifically for a child. The cellular phone comprises a key of receiving a call, a plurality of cursor movement keys, a cancel key, and a game key. Also, a plurality of software packages including a plurality of game software packages and a software package of receiving a call are installed in the cellular phone. Hence, a user may press either the key of receiving a call for receiving a call or the cancel key to end a call. Alternatively, the user can press the game key and at least one of the cursor movement keys to play a game provided by the game software on the cellular phone.

Another object of the present invention is to provide a cellular phone designed specifically for an old person. The cellular phone comprises a plurality of large shortcut keys on its front surface for dialing, a plurality of software packages are installed in a driver of the cellular phone, each software package being linked to a corresponding phone number, and a plurality of appropriate picture (e.g., pictures of friend, relative, or the like) each adhered on the corresponding shortcut key. Thus, a user can press a selected shortcut key as guided by the picture labeled thereon for making a call to a desired person in a simple way.

The above and other objects, features and advantages of the present invention will become apparent from the following detailed description taken with the accompanying drawings.

### BRIEF DESCRIPTION OF THE DRAWINGS

FIG. 1 is a front plan view of a first preferred embodiment of cellular phone for child according to the invention in a default operating state;

FIG. 2 is a view similar to FIG. 1 where another operating state of the FIG. 1 cellular phone is illustrated;

FIG. 3 is a front plan view of a second preferred embodiment of cellular phone for old person according to the invention in a default operating state; and

FIG. 4 is a view similar to FIG. 3 where another operating state of the FIG. 3 cellular phone is illustrated.

### DETAILED DESCRIPTION OF THE PREFERRED EMBODIMENTS

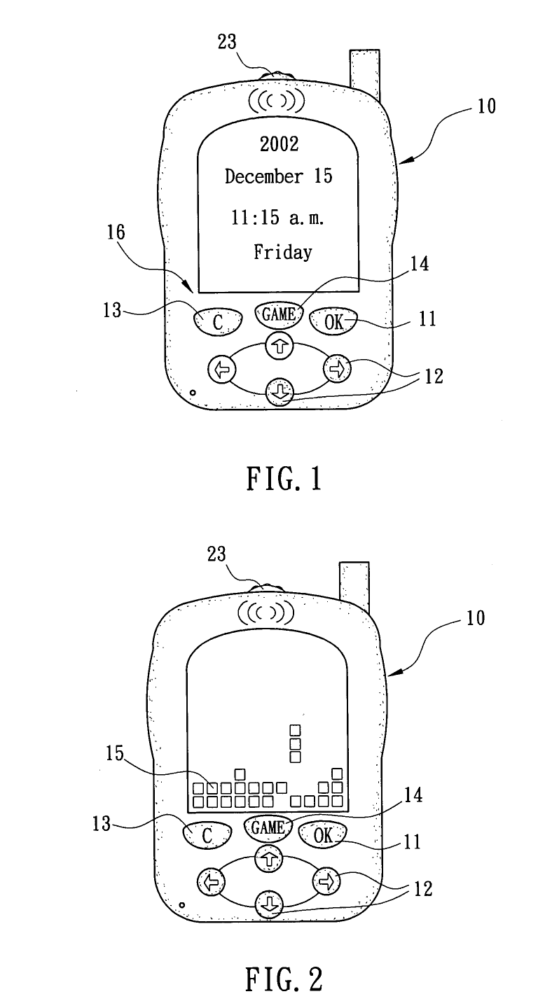

Referring to FIG. 1, there is shown a cellular phone for a specific person in accordance with the invention. Specifically, the cellular phone is designed for an unskillful person (e.g., old person or child), a deaf person, or people with other disabilities. The cellular phone 10 comprises a control circuit having a plurality of software packages installed therein. The software packages are adapted to make or receive a call. An interface for setting phone numbers is provided on each software package. The cellular phone 10 further comprises a plurality of keys 16 on its front surface. The keys 16 are linked to the software packages. Hence, a pressing of one key 16 may run a corresponding software package for causing the cellular phone 10 to make a call by dialing the selected, predetermined phone number. The cellular phone 10 further comprises at least one port having one end electrically coupled to the control circuit thereof. As such, a user can set phone numbers on the interface via the port. Alternatively, the port can be used to interconnect the cellular phone 10 and a computer so as to set phone numbers on the interface by means of the computer. In such a manner, a user can simply press one of the keys 16 to cause the cellular phone 10 to make a call. In other words, a user can easily use the cellular phone 10 without worrying about how to use it. At the same time, neither complicated function keys nor complicated software packages are provided on the cellular phone 10. As an end, a manufacturing cost of the cellular phone 10 is greatly reduced.

In a first preferred embodiment of the invention the cellular phone is designed specifically for a child. A typical reason for parents to buy a cellular phone for their child is that they want to know the whereabouts of the child at any time. But the parents also worries that the child may use the cellular phone recklessly, resulting in a great increase of telephone bill. For solving the problem the cellular phone of the invention is restricted to receive a call only rather than make a call as designed. Further, a game software is installed in the cellular phone so that a user not only can receive a call but also can play a game provided by the game software on the cellular phone and download latest game software from the Internet by coupling to a computer.

Referring to FIGS. 1 and 2, the cellular phone 10 further comprises a key of receiving a call 11, a plurality of cursor movement keys 12, a cancel key 13, and a game key 14. As stated above, the plurality of software packages are installed in the cellular phone 10. The software packages comprise game software packages and a software package of receiving a call. A user may press either the key of receiving a call 11 for receiving a call or the cancel key 13 to end a call. Alternatively, a user can press the game key 14 and at least one of the cursor movement keys 12 to play a game 15 provided by the game software on the cellular phone 10.

Referring to FIGS. 1 and 2 again, in the first preferred embodiment of the invention the cellular phone 10 further a volume control knob 23 on a top side. The volume control knob 23 is electrically coupled to the control circuit of the cellular phone 10. As such, a user may turn the volume control knob 23 for adjusting volume adapted to his/her hearing while using the cellular phone 10.

In a second preferred embodiment of the invention the cellular phone is designed specifically for an old person. Typically, an old person does not have the skill to operate a powerful, complicated cellular phone. Also, the area of a keypad of the cellular phone is required to be as large as possible for ease of use. Further, most old persons are poor in memory. Hence, many old persons may easily forget one or more shortcut keys linked to the specific person(s). For solving this problem, a driver capable of directly receiving a call is installed in the cellular phone by the invention. Also, several large shortcut keys with appropriately labeled pictures for representing them are provided on the cellular phone by the invention.

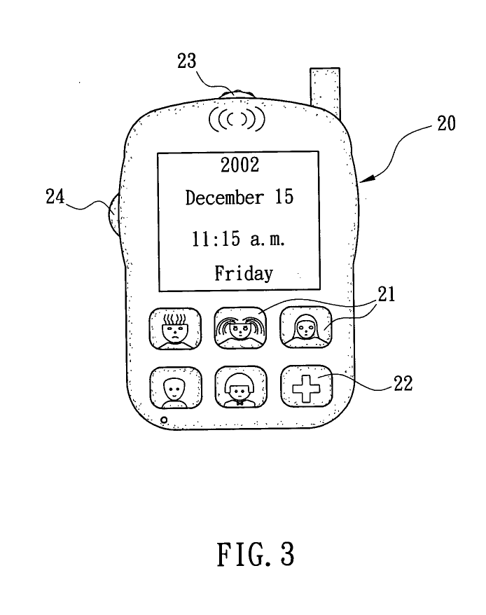

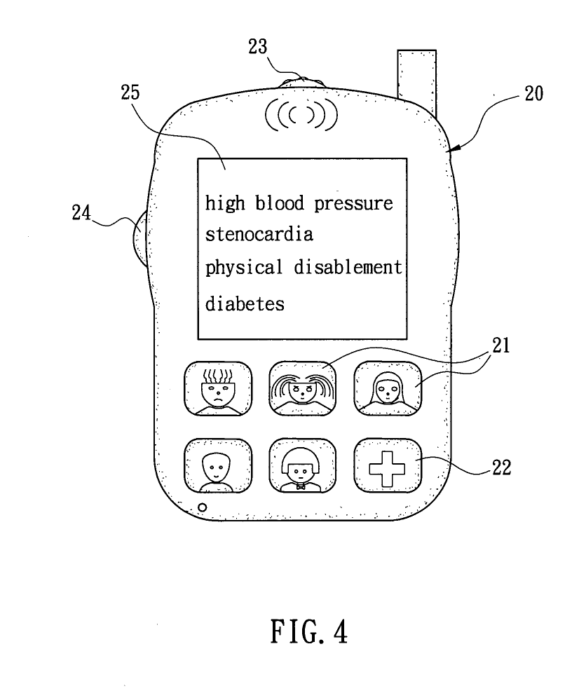

Referring to FIGS. 3 and 4, a cellular phone 20 of the second preferred embodiment of the invention comprises a control circuit having a plurality of software packages installed therein. The software packages include a software package of receiving a call and an interface for setting phone numbers. The cellular phone 20 further comprises a plurality of large shortcut keys 21 on its front surface for dialing. An appropriate picture (e.g., picture of friend, relative, or the like) is adhered on each shortcut key 21 for helping the old person memorize it. A corresponding software package is activated when one of the shortcut keys 21 is pressed. Next, the cellular phone 20 is activated to make a call by dialing the selected, predetermined phone number. The cellular phone 20 further comprises at least one port having one end electrically coupled to the control circuit thereof. The port can be used to interconnect the cellular phone 20 and a computer. As such, a corresponding phone number of each shortcut key 21 can be set on the interface by means of the computer. Thus, a user can press a selected shortcut key 21 as guided by the picture labeled thereon for making a call to a desired person. For example, a picture of the old person's daughter is labeled on one of the shortcut keys 21. Hence, the old person can press the shortcut key 21 with his/her daughter picture labeled thereon without consideration prior to making a call to her. Also, the cellular phone 20 can automatically receive an incoming call. The cellular phone 20 will automatically hang up when the call is over.

Referring to FIGS. 3 and 4 again, in the second preferred embodiment one of the shortcut keys 21 is a help key 22 for emergency. Also, an indicator (e.g., LED (light emitting diode)) is provided below the help key 22. The indicator is electrically coupled to the control circuit of the cellular phone 20. The indicator can be flashed for visually indicating the position of the help key 22 to a user. A set of phone number and recording of help voice linked to the help key 22 is provided in a driver of the cellular phone 20. An old person thus can press the help key 22 to make an emergency call in case of danger (e.g., robbery, sudden illness, etc.)

Referring to FIGS. 3 and 4 again, in the second preferred embodiment the cellular phone 20 further a volume control knob 23 on a top side. The volume control knob 23 is electrically coupled to the control circuit of the cellular phone 20. As such, a user may turn the volume control knob 23 for adjusting volume adapted to his/her hearing while using the cellular phone 20.

Referring to FIGS. 3 and 4 again, in the second preferred embodiment the cellular phone 20 further a health problem knob 24 at a side. Also, a plurality of records of disease or disability (e.g., high blood pressure, stenocardia, physical disablement, diabetes, or the like) 25 are provided on the driver of the cellular phone 20. As such, a user may turn the health problem knob 24 to show a number of diseases or disabilities 25 on the display of the cellular phone 20 for reference. Accordingly, the user can know his/her health condition immediately.

While the invention has been described by means of specific embodiments, numerous modifications and variations could be made thereto by those skilled in the art without departing from the scope and spirit of the invention set forth in the claims.

1. A cellular phone for a specific person who is not skilled in operating a typical cellular phone, comprising:
a plurality of software packages installed in a control circuit of the cellular phone, the software packages being adapted to make or receive a call, each of the software packages including an interface for setting phone numbers;
at least one port on the cellular phone, each port having one end electrically coupled to the control circuit so that a user can set phone numbers on the interface via the port; and
a plurality of large shortcut keys on the cellular phone, the shortcut keys being linked to the software packages so that a pressing of one of the shortcut keys causes a corresponding software package to run for commanding the cellular phone to make a call by dialing a selected one of a plurality of predetermined phone numbers.

2. The cellular phone of claim 1, further comprising a plurality of auxiliary pictures each labeled on a corresponding shortcut key so as to facilitate a user to press a selected one of the shortcut keys for making a call.

3. The cellular phone of claim 1, wherein each port is adapted to interconnect the cellular phone and a computer so as to set phone numbers on the interface by means of the computer.

4. The cellular phone of claim 1, further comprising a help key, an indicator below the help key, the indicator being electrically coupled to the control circuit so that a flashing of the indicator is able to visually indicate the position of the help key, and a set of phone number and recording of help voice linked to the help key in a driver of the cellular phone so that a pressing of the help key can make an emergency call in case of danger.

5. The cellular phone of claim 1, wherein the cellular phone further comprises a volume control knob on a side, the volume control knob being electrically coupled to the control circuit so that a user is able to turn the volume control knob for adjusting volume adapted to the user's hearing while using the cellular phone.
